(19) United States
(12) Patent Application Publication
(10) Pub. No.: US 2022/0351295 A1
(43) Pub. Date: Nov. 3, 2022

(54) COMPUTER-IMPLEMENTED METHOD FOR CREATING AND MAINTAINING A FINANCIAL INDEX

(71) Applicant: WHAT?S NEXT MEDIA AND ANALYTICS LLC, Boston, MA (US)

(72) Inventor: Karen WEBSTER, Boston, MA (US)

(21) Appl. No.: 17/728,936

(22) Filed: Apr. 25, 2022

Related U.S. Application Data
(60) Provisional application No. 63/178,811, filed on Apr. 23, 2021.

(51) Int. Cl. G06Q 40/06

(52) U.S. Cl. CPC G06Q 40/06

(57) ABSTRACT

A computer-implemented method for creating and maintaining a financial index using an improved analytic framework, the financial index directed to the state of how people and businesses interact, both individually and collectively, in the global economy. The financial index measures the price performance of securities that are identified as companies contributing to the digital transformation and growth of the connected economy—specifically, companies that directly contribute to the digital transformation and growth of the connected economy and those that provide the software and infrastructure to enable it.

### CROSS-REFERENCE TO RELATED APPLICATIONS

This application claims the benefit of U.S. Provisional Patent Application No. 63/178,811 filed Apr. 23, 2021, incorporated by reference.

### FIELD OF THE INVENTION

The present invention is generally related to a computer-implemented method for creating and maintaining a financial index. More particularly, the index is formulated using an improved analytic framework to examine, track, and report the state of how people and businesses interact, both individually and collectively, in the global economy.

### BACKGROUND OF THE INVENTION

The digital transformation refers to changes in the production and distribution of goods and services throughout the economy resulting from the integration of internet-based technologies. It began with the launch of the commercial Internet in the mid 1990s. As with most general-purpose technologies, the commercial internet, combined with other innovations, gradually changed the economy overall through disruptive and incremental innovation, creating new products and services and the reinvention of how things are done.

Almost every point of physical space now has internet connectivity because of the spread of mobile broadband, with exponentially rising speeds, through most of the populated areas of the world. That, along with faster and more pervasive fixed broadband, has resulted in almost every person having access to powerful computers, software and other technologies almost all the time. Through the internet, everyone, and all points of physical space, are able to connect with everyone else. In addition to personal computers, smartphones and mobile apps, and increasingly voice-activated devices, provide access.

These technologies make new ways to do things possible. For example, fast grocery delivery is enabled through the interconnection, in real time, of the store, customer, shopper and driver. Telemedicine is aided through linking the doctor, patient, medical records and diagnostic apps. Connected cars receive software updates through mobile broadband and services provided in the cloud.

While much has happened since the launch of the commercial internet, and change seems rapid for those who have lived through the last three decades, it is apparent that these still are early days. Some areas seem far along, such as search, social and, to a lesser extent, eCommerce. Others are just catching on after more than a decade of gestation, such as ride sharing, grocery delivery and telemedicine. Many new areas, such as the metaverse and decentralized finance, hold unknown promise. Then there are all the areas that are not known or have yet to be thought of. More recently, this transformation has enabled people to try digital solutions and overcome inertia.

The digital transformation likely will take many decades to work its way through the economy, however there is no known method to track the digital transformation of the global economy comprising connected ecosystems and a diversity of connected devices, referred to as the “connected economy”.

Most indexes attempt to measure value and provide an indicator of performance of the group of asset or securities. Indices have been used by investors as market indicators and for constructing investment portfolios, funds, or other products and services linked to one or more indices. An index tracks the performance of a group of asset or securities. A broad-based index captures the entire market, such as the Standard & Poor's 500 (S&P 500) Index or Dow Jones Industrial Average (DJIA). The S&P 500 Index is a market-capitalization-weighted index of the 500 largest publicly traded companies in the U.S. The DJIA index tracks 30 large, publicly owned blue-chip companies trading on the New York Stock Exchange and the NASDAQ.

The Internet of Things (IoT) has resulted in a connected economy, i.e., every device connected to the internet is capable of enabling some sort of transaction—between machines, people, businesses, to name a few.

As the connected economy grows, the performance of companies' changes. Traditional measurements used by investors fail to fully capture the extent of the connected economy. A more purposeful focus on how people and businesses interact, individually and collectively, may be captured in a financial index. What is needed is an improved analytic framework to examine, track, and report the state of companies in the connected economy. The invention satisfies this need.

### SUMMARY OF THE INVENTION

The invention is directed to an improved analytic framework to examine, track, and report the state of companies in the connected economy. According to the invention, a financial index is formulated by scoring features selected to represent a qualitative and a quantitative mix of data of the state of companies in the connected economy, wherein features are scored within categories to select companies of the financial index. Specifically, the financial index measures the price performance of securities that are identified as those contributing to the digital transformation and growth of the connected economy.

A number of categories are predefined to characterize companies that directly contribute to the digital transformation and growth of the connected economy and those that provide the software and infrastructure to enable it. According to one embodiment of the invention, 11 categories are predefined as “work”, “pay”, “eat”, “shop”, “live”, “move”, “bank”, “be well”, “have fun”, “communicate”, “enabler”.

Companies are identified across these categories and each company reviewed for predetermined features within each category. These predetermined features consider whether the company has highly evolved digital capabilities in the category for which they are being considered, whether there is evidence that the company has or likely will expand into adjacent areas from their core capability, whether the company had technology and data asset that provide a foundation for innovation, and the extent to which the company is inventing in key digital capabilities, including research and development, partnerships and acquisitions.

The features are scored for each company. It is contemplated that scoring of the features may be weighted. For example, to consider the varying degrees of importance of each feature. All feature scores are added to arrive at a final score for each company.

Based on the final scores, a certain number of companies are selected from each category to comprise the index. According to one embodiment, at least one company is selected from each category.

Each of the categories are equally weighted (Le., unweighted). By adopting equal weights, the index summarizes the performance of diverse companies across the connected economy. Furthermore, unweighted indexes have been generally found to perform better than market-cap weighted indexes.

The present invention and its attributes and advantages will be further understood and appreciated with reference to the attached figures of presently contemplated embodiments. Further modifications and alternative embodiments of various aspects of the invention will be apparent to those skilled in the art. Accordingly, this description is to be construed as illustrative only and is for the purpose of teaching those skilled in the art the general manner of carrying out the invention.

### BRIEF DESCRIPTION OF THE DRAWINGS

The preferred embodiments of the invention will be described in conjunction with the appended drawings provided to illustrate and not to limit the invention.

FIG. 1 is a flowchart of the steps performed by a computer-implemented method according to the invention.

FIG. 2 is a block diagram of the categories predefined according to the invention.

FIG. 3 is a block diagram of the predetermined features according to the invention.

FIG. 4 illustrates an exemplary computer system that may be used to implement the methods according to the present invention; and

FIG. 5 illustrates a cloud-based system that may be used to implement the methods according to the present invention.

### DETAILED DESCRIPTION OF EMBODIMENTS OF THE INVENTION

A computer-implemented method for creating and maintaining a financial index using an improved analytic framework, the financial index directed to the state of how people and businesses interact, both individually and collectively, in the global economy. Specifically, the financial index measures the price performance of securities that are identified as those contributing to the digital transformation and growth of the connected economy.

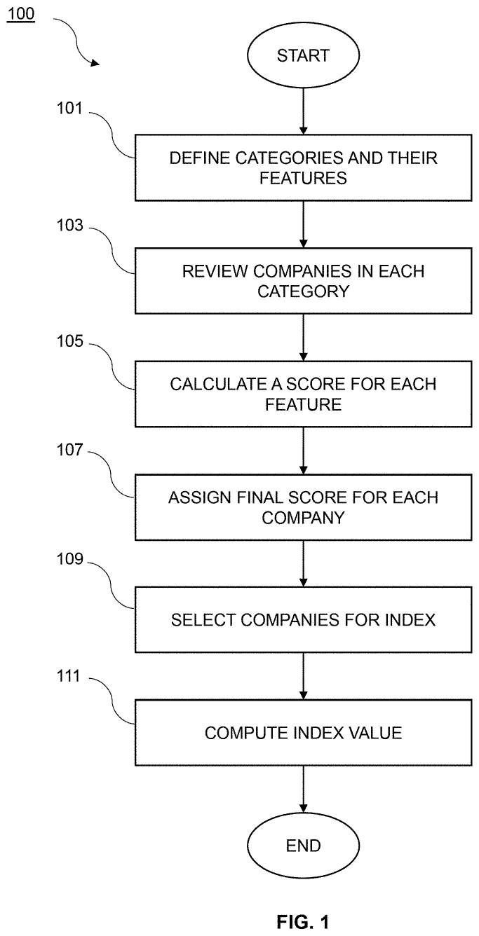

FIG. 1 is a flowchart 100 of the steps performed by a computer-implemented method. Instructions for performing the steps are stored in one or more non-transitory mediums. At step 101 a plurality of categories is defined.

According to one embodiment of the invention, 11 categories are predefined as “work”, “pay”, “eat”, “shop”, “live”, “move”, “bank”, “be well”, “have fun”, “communicate” for those companies that directly contribute to the digital transformation. And the category “enabler” is for those companies that provide the software and infrastructure that power the transformation and growth of the economy.

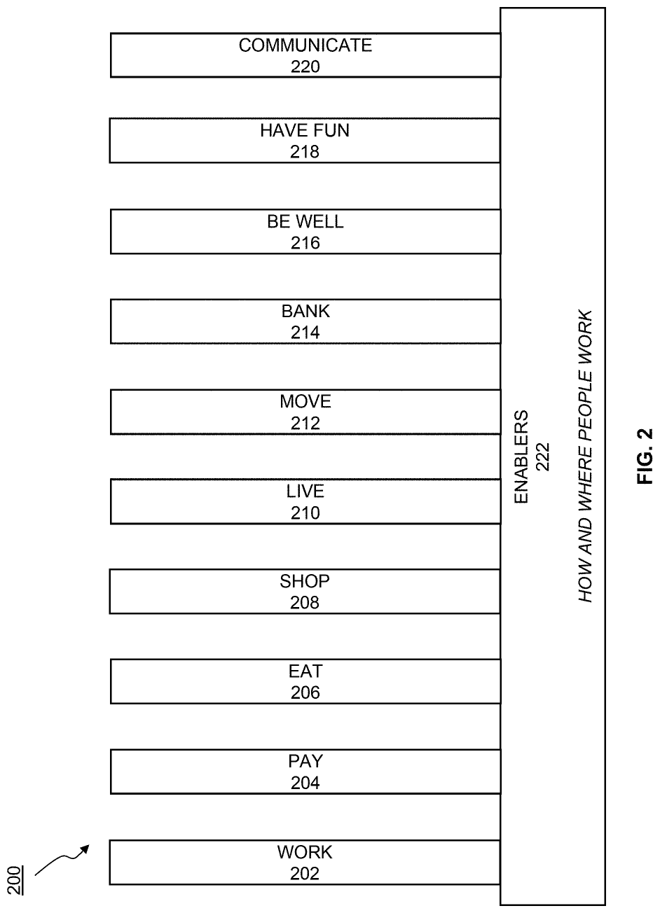

FIG. 2 is a block diagram 200 of the categories predefined according to the invention. The first category—work 202—analyzes how and where people work. The second category—pay 204—analyzes how people are paid and how they pay others. The third category—eat 206—analyzes how and where people buy food and eat. The fourth category—shop 208—analyzes how and where people find things to buy and how and where people buy them. The fifth category—live 210—analyzes how smart technologies change how people use their homes and their interactions in the locations they live and work. The sixth category—move 212—analyzes how and where people and products move from point A to point B. The seventh category—bank 214—analyzes how and where people save, store and access their money. The eighth category—be well 216—analyzes how and where people consume healthcare services to stay healthy. The ninth category—have fun 218—analyzes how and where people spend their leisure time. The tenth category—communicate 220—analyzes how people keep in touch with family, friends and business partners. The last category—enablers 222—analyzes the goods and services that make it all possible; these include data and technologies, payment players, artificial intelligence, software platforms, third-party solutions, and cellular technologies, to name a few. Although the invention is described with respect to 11 categories, any number of categories is contemplated.

Also, at step 101 in FIG. 1, a plurality of features within each category are predetermined. These predetermined features consider whether the company has highly evolved digital capabilities in the category for which they are being considered, whether there is evidence that the company has or likely will expand into adjacent areas from their core capability, whether the company had technology and data asset that provide a foundation for innovation, and the extent to which the company is inventing in key digital capabilities, including research and development, partnerships and acquisitions.

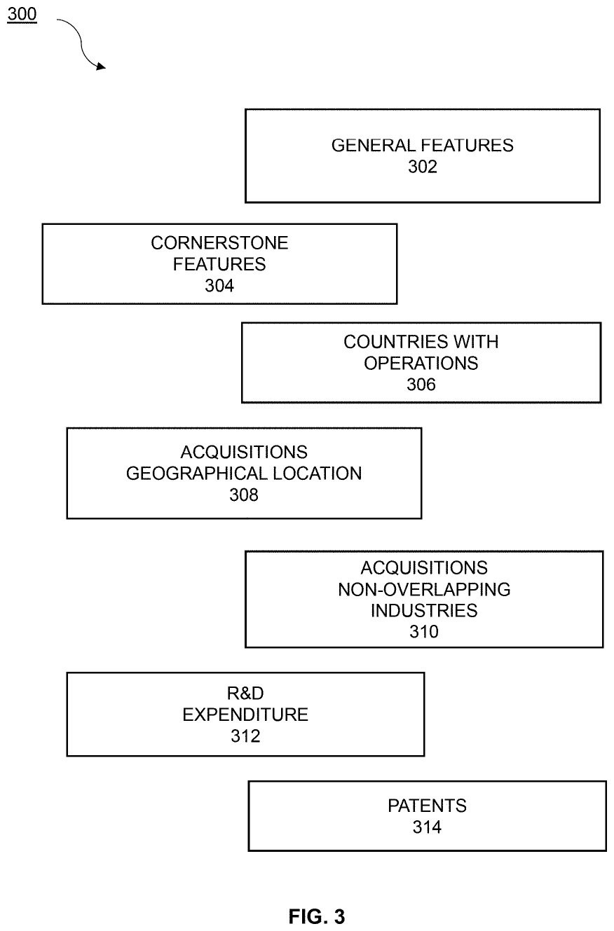

Based on these considerations, one embodiment of the invention determines the features as shown by the block diagram of FIG. 3: one or more general features 302, one or more cornerstone features 304, a number of countries with operations 306, acquisitions based on a geographical location of acquirees 308, acquisitions based on the number of non-overlapping industries with regards to the acquiree 310, expenditure in research and development (R&D) 312, and a number of patents 314.

At step 103 in FIG. 1, companies in each category are reviewed for each feature. For each company, a score is calculated for each feature at step 105.

The weight assigned to each feature depends on the number of companies that offer it: if a feature is offered by all companies in the index, its score is 0 (e.g., all companies have a website, so it's trivial to have one). If only one company offers it, the weight is at its maximum possible value (this value depends on the number of companies in the final version of the index).

A general feature score GFS_{c} is defined as:

GFS_{c}=EW_{c}*FS_{c}

where EW_{c} represents an essential features weight for company c and FS_{c} represents a general intermediate feature score. The general intermediate feature score FS_{c} is a sum of individual feature scores, each individual feature score defined by:

$${FS}_{f} = \frac{1 - \frac{{n}_{f}}{N}}{F - {\sum }_{f = 1}^{f = {In}_{\frac{f}{N}}}}$$

where n_{f} represents the number of companies (C) with the feature (the subindex f represents each feature), N represents the total number of companies under analysis, F represents a total number of features, and FS_{f} represents the score for a given feature.

While the scoring method for “All features” provides a higher score to companies which offer infrequent features, it doesn't take into account that if a company fails to provide a feature that is present in most companies, all of its operations will suffer because of that. If a company provides only niche features, but fails to provide common ones, it might suffer for it. Having a feature that's essential to have doesn't add to a company score, but lacking it detracts from its score.

An essential feature is one that is present in more than 90% of companies. The score for all features is weighted by the proportion of essential features present in a company.

The essential features weight EW_{c} for company c is defined as:

$${EW}_{c} = \frac{{e}_{c}}{E}$$

where EW_{c} represents an essential features weight for company c, e_{c} represents the number of essential features present in company c, E represents the total number of features.

The final score for each company, regarding its cornerstone features, is KFS_{ck} defined by:

KFS_{ck}=KEW_{ck}*KFS_{fk}

where KEW_{ck} represents an essential features weight for company ck and KFS_{fk} represents a specific score for a given feature in that cornerstone.

Cornerstone features are those that are specific to that cornerstone. A feature is considered to belong to a specific cornerstone if it's present in more than 75% of companies that operate within that cornerstone, or it is considered to be part of it. Calculation of the score for a given feature is done in a very similar manner to the calculation of the general feature score. The cornerstone feature score KFS_{ck} is defined by:

$${KFS}_{fk} = \frac{1 - \frac{{n}_{fk}}{{N}_{k}}}{{F}_{k} - {\sum }_{fk = 1}^{fk = {Ikn}_{\frac{fk}{N}}}}$$

where n_{fk} is the number of companies in that cornerstone with a feature (the subindex fk represents each feature from that cornerstone), Nₖ is the total number of companies under analysis that operate within a given cornerstone, Fₖ is the total number of features for a given cornerstone, KFS_{fk} is the specific score for a given feature in that cornerstone.

The essential features weight KEW_{ck} is defined by:

$${KEW}_{ck} = \frac{{ke}_{ck}}{kE}$$

where KEW_{ck} is the essential features weight for company ck, e_{ck} is the number of essential features present in company ck, E is the total number of features.

Entering a new market means that a company is ready to face new challenges related to that market, understand new regulations and be ready to compete in a different environment than its original one. While not being R&D in itself, the capacity of a company to expand its operations abroad are a sign of its dynamism.

The score assigned to this category is linear and depends on the position rank of a given company with regards to the number of countries in which it operates (the rank is only calculated over the list of companies in the index). The formula to assign a given company c a specific score is the following:

$${CS}_{c} = \frac{AscendingRank ( {Countries}_{c} )}{C}$$

where C is the total number of companies in the index.

An acquisition might help a company not only expand its total size, but also to enter a new industry or a new market. The acquisition score takes these two variables into account.

An industry score is determined by using public information to measure the level of overlap between the company under analysis and its acquired companies. A low overlap means that the acquirer company was willing to start operating in a new industry, which correlates to a higher innovation score.

For each acquisition, overlap is measured as the sum of non-overlapping industries over the total number of industries in which the acquiree operates. For each acquisition, which is equal to:

$${Overlap\_Weight}_{a} = \frac{Acquiree\_NonOverlapping \_Industries}{Acquiree\_Industries}$$

where the subindex a refers to the acquisition.

In order to get the total score for a company (the acquirer), its overlap weights are summed, and the company assigned a rank based on that:

$${AIS}_{c} = \frac{AscendingRank ( \sum {Overlap\_Weigth}_{a} )}{C}$$

This means that if the acquiree industries are all comprehended in the list of industries in which the acquirer operates, the company will receive the lowest score possible (regardless on the number of acquisitions it did).

Initially, acquisitions are weighted according to the place of operations of the acquiree. In acquisitions where the acquiree and the acquirer operated in different countries, the acquisition weight was halved. Otherwise, when the acquirer and the acquiree operated in different countries, the acquisition weight was full. The full formula for country score was then:

$${ACS}_{c} = \frac{AscendingRank ( \begin{matrix}\sum {InternationalAcquisitions}_{c} + \\ \frac{{SameCountryAcquisitions}_{c}}{2}\end{matrix} )}{C}$$

R&D expenditure is researched using public accounting data from the analyzed companies. If the companies operated in countries other than the US, their reported R&D expenditure is converted to USD. Then, companies are ranked according to their total expenditure. The scoring formula assigned to the absolute expenditure in research and development (R&D) AbsRDS_{c} is defined by:

$$A b s R D {S}_{c} = 7.5 * \frac{A s c e n d i n g R a n k ( R \& {D \_ Expenditure}_{c} )}{C}$$

where C is the total number of companies in the index and c is the company.

While larger companies get a higher score regarding the Total R&D Expenditure, it's also important to assess the level of importance a company gives to its research in comparison to the total size of the company. In order to assess that, the ratio between R&D expenditure and company revenues is used. The scoring formula for the ratio between its R&D expenditure and its revenues RelRDS_{c} is defined by:

$${RelRDS}_{c} = 7.5 * \frac{A s c e n d i n g R a n k ( \frac{R \& {D \_ Expenditure}_{c}}{{Revenue}_{c}} )}{C}$$

where C is the total number of companies in the index and c is the company.

The score assigned to patents is always based on the rank of the number of patents filed by the company in a given period, but different periods are scored differently. For a given period t, a company base score is calculated as:

$$P {S}_{c} ( t ) = \frac{A s c e n d i n g R a n k ( P a t e n t {s}_{c} ( t ) )}{C}$$

where C is the total number of companies in the index and t is time.

Then, a different weight is assigned to different periods of time. Patents older than a year from the beginning of the current semester are weighted 2/10 of the patent score. Patents which are 2 semesters old are weighted 3/10 of the patent score. Patents which are one semester old are weighted 4/10 of the patent score, and patents which are filed in the current semester are only weighted 1/10 of the patent score. The reason for that is that there might be a delay with regards to its publication on public sources, regardless of the date in which it was actually filed. Punishing companies for publication delays would detract from the capacity to measure their actual innovation. Therefore, the final formula for this part of the score is:

TPS_{c}=0.2*PS_{c}(<−2)+0.3*PS_{c}(−2)+0.4*PS_{c}(−1)+0.1*PS_{c}(0)

where PS_{c} is a score based on a rank of a number of patents filed by the company c in a given period.

At step 107, a final score for each company in each category is assigned by summing the score for all features for each company. The final score is defined as:

FS_{c}=10*GFS_{c}+20KFS_{ck}+10*CS_{c}+10*AIS_{c}+10*ACS_{c}+7.5*AbsRDS_{c}+7.5*RelRDS_{c}+25*TPS_{c}

where FS_{c} is the final score of a company, GFS_{c} is a general features score, KFS_{ck}is a cornerstone feature score, CS_{c} is a score assigned to the number of countries where it operates, AIS_{c} is a score assigned to its acquisitions based on the geographical location of the acquirees, ACS_{c} is a score assigned to its acquisitions based on the number of non-overlapping industries with regards to the acquiree, AbsRDS_{c} is a score assigned to its absolute expenditure in research and development (R&D), RelRDS_{c} is a score assigned to the ratio between it R&D expenditure and its revenues, TPS_{c} is a total score assigned to the number of patents the company has filed throughout its history.

According to one embodiment, the companies are selected that have a final score FS_{c}≥a predetermined value. In certain embodiments, this value may be a value closest to 100. Examples include a predetermined value of 90, or 95, even 99. The value may be predetermined based on the median value or mean value of scores.

At step 109 a total number of companies is selected for the financial index. According to one embodiment, the total number of companies is 100. In another embodiment of the invention, 50 companies are selected. Although these are the preferred embodiments, any number of companies is contemplated. At least one company is selected from each category. And preferably, between and including 3 and 15 companies are selected from each category.

An average percent change in equity prices for each selected company are used to compute the value of the financial index at step 111. Specifically, the financial index according to the invention is defined as:

$$I N D E {X}_{t} = INDE {X}_{t - 1} * ( 1 + \frac{{\sum }_{i = 1}^{{n}_{t}} \frac{{P}_{t}^{i} - {P}_{t - 1}^{i}}{{P}_{t - 1}^{i}}}{{n}_{t}} ) , {n}_{t} ∈ \{ 1 , … , 100 \}$$

where P representing the average percent change in equity prices, and t represents time.

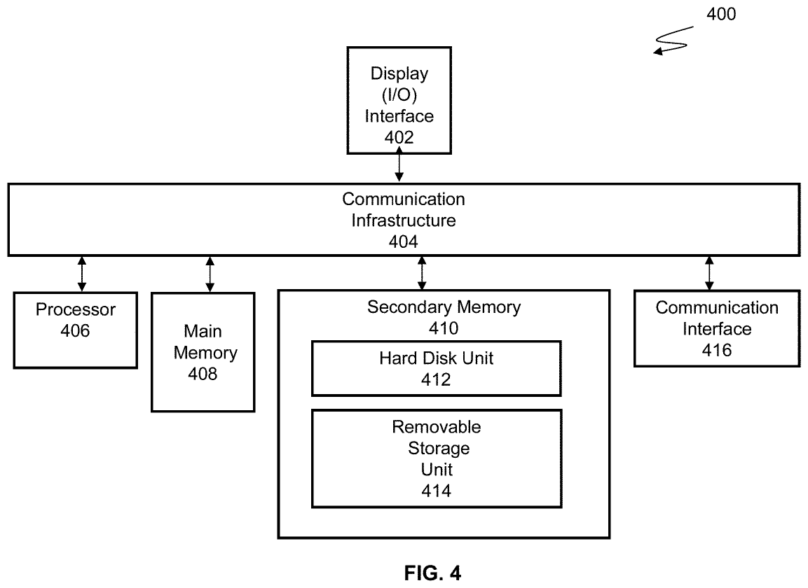

FIG. 4 illustrates a diagram of a system of which may be an embodiment of the present invention. Computer system 400 includes an input/output interface 402 connected to communication infrastructure 404—such as a bus—, which forwards data such as graphics, text, and information, from the communication infrastructure 404 or from a frame buffer (not shown) to other components of the computer system 400. The input/output interface 402 may be, for example, a display device, a keyboard, touch screen, joystick, trackball, mouse, monitor, speaker, printer, ocular unit, web camera, any other computer peripheral device, or any combination thereof, capable of entering and/or viewing data.

Computer system 400 includes one or more processors 406, which may be a special purpose, or a general-purpose digital signal processor configured to process certain information. Computer system 400 also includes a main memory 408, for example random access memory (RAM), read-only memory (ROM), mass storage device, or any combination thereof. Computer system 400 may also include a secondary memory 410 such as a hard disk unit 412, a removable storage unit 414, or any combination thereof. Computer system 400 may also include a communication interface 416, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 408, secondary memory 410, communication interface 416, or a combination thereof, function as a computer usable storage medium, otherwise referred to as a computer readable storage medium, to store and/or access computer software including computer instructions. For example, computer programs or other instructions may be loaded into the computer system 400 such as through a removable storage device, for example, a floppy disk, ZIP disks, magnetic tape, portable flash drive, optical disk such as a CD or DVD or Blu-ray, Micro-Electro-Mechanical Systems (MEMS), nanotechnological apparatus. Specifically, computer software including computer instructions may be transferred from the removable storage unit 414 or hard disc unit 412 to the secondary memory 410 or through the communication infrastructure 404 to the main memory 408 of the computer system 400.

Communication interface 416 allows software, instructions and data to be transferred between the computer system 400 and external devices or external networks. Software, instructions, and/or data transferred by the communication interface 416 are typically in the form of signals that may be electronic, electromagnetic, optical or other signals capable of being sent and received by the communication interface 416. Signals may be sent and received using wire or cable, fiber optics, a phone line, a cellular phone link, a Radio Frequency (RF) link, wireless link, or other communication channels.

Computer programs, when executed, enable the computer system 400, particularly the processor 406, to implement the methods of the invention according to computer software including instructions.

The computer system 400 described may perform any one of, or any combination of, the steps of any of the methods according to the invention. It is also contemplated that the methods according to the invention may be performed automatically.

The computer system 400 of FIG. 4 is provided only for purposes of illustration, such that the invention is not limited to this specific embodiment. It is appreciated that a person skilled in the relevant art knows how to program and implement the invention using any computer system.

The computer system 400 may be a handheld device and include any small-sized computer device including, for example, a personal digital assistant (PDA), smart hand-held computing device, cellular telephone, or a laptop or netbook computer, handheld console or MP3 player, tablet, or similar handheld computer device, such as an iPad®, iPad Touch® or iPhone®.

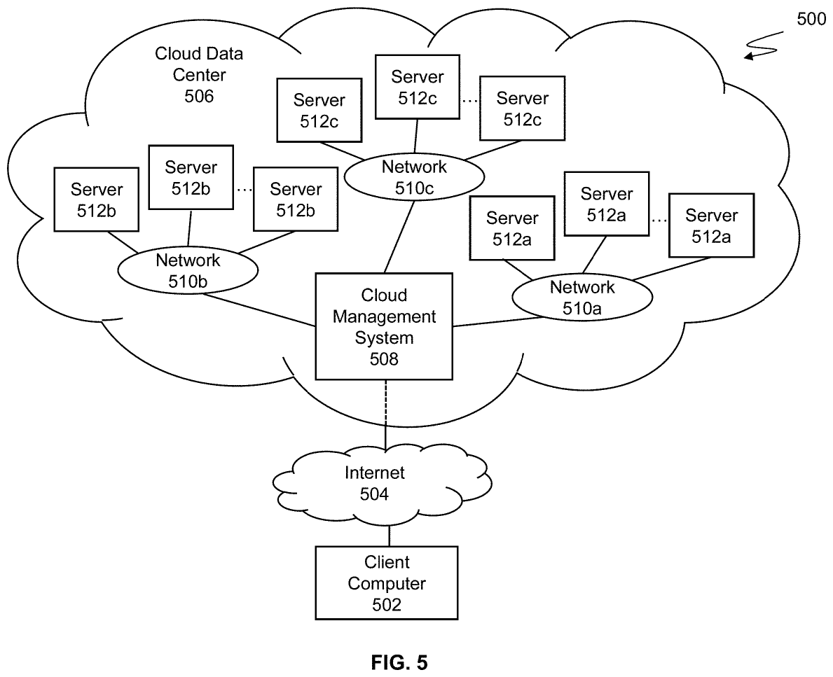

FIG. 5 illustrates an exemplary cloud computing system 500 that may be an embodiment of the present invention. The cloud computing system 500 includes a plurality of interconnected computing environments. The cloud computing system 500 utilizes the resources from various networks as a collective virtual computer, where the services and applications can run independently from a particular computer or server configuration making hardware less important.

Specifically, the cloud computing system 500 includes at least one client computer 502. The client computer 502 may be any device through the use of which a distributed computing environment may be accessed to perform the methods disclosed herein, for example, a traditional computer, portable computer, mobile phone, personal digital assistant, tablet to name a few. The client computer 502 includes memory such as random-access memory (RAM), read-only memory (ROM), mass storage device, or any combination thereof. The memory functions as a computer usable storage medium, otherwise referred to as a computer readable storage medium, to store and/or access computer software and/or instructions.

The client computer 502 also includes a communications interface, for example, a modem, a network interface (such as an Ethernet card), a communications port, a PCMCIA slot and card, wired or wireless systems, etc. The communications interface allows communication through transferred signals between the client computer 502 and external devices including networks such as the Internet 504 and cloud data center 506. Communication may be implemented using wireless or wired capability such as cable, fiber optics, a phone line, a cellular phone link, radio waves or other communication channels.

The client computer 502 establishes communication with the Internet 504—specifically to one or more servers—to, in turn, establish communication with one or more cloud data centers 506. A cloud data center 506 includes one or more networks 510a,510b, 510c managed through a cloud management system 508. Each network 510a, 510b, 510c includes resource servers 512a, 512b, 512c, respectively. Servers 512a, 512b, 512c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 508 can comprise a dedicated or centralized server and/or other software, hardware, and network tools to communicate with one or more networks 510a, 510b, 510c, such as the Internet or other public or private network, with all sets of resource servers 512a, 512b, 512c. The cloud management system 508 may be configured to query and identify the computing resources and components managed by the set of resource servers 512a, 512b, 512c needed and available for use in the cloud data center 506. Specifically, the cloud management system 508 may be configured to identify the hardware resources and components such as type and amount of processing power, type and amount of memory, type and amount of storage, type and amount of network bandwidth and the like, of the set of resource servers 512a, 512b, 512c needed and available for use in the cloud data center 506. Likewise, the cloud management system 508 can be configured to identify the software resources and components, such as type of Operating System (OS), application programs, and the like, of the set of resource servers 512a, 512b, 512c needed and available for use in the cloud data center 506.

The present invention is also directed to computer products, otherwise referred to as computer program products, to provide software to the cloud computing system 500. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (MEMS), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 500 of FIG. 5 is provided only for purposes of illustration and does not limit the invention to this specific embodiment. It is appreciated that a person skilled in the relevant art knows how to program and implement the invention using any computer system or network architecture.

While the disclosure is susceptible to various modifications and alternative forms, specific exemplary embodiments of the invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. A computer-implemented method of creating a financial index, the method comprising instructions stored in one or more non-transitory mediums for performing the steps of:
defining a plurality of categories and a plurality of features within each category;
reviewing companies in each category for each feature;
calculating for each company a score for each feature;
assigning a final score for each company in each category by summing the score for all features for each company;
selecting a total number of companies in the financial index, wherein at least one company is selected from each category with the final score a predetermined value; and
computing the value of the financial index by using an average percent change in equity prices for each selected company.

2. The method of claim 1, wherein the plurality of features comprises one or more selected from the group consisting of: one or more general features, one or more cornerstone features, a number of countries with operations, acquisitions based on a geographical location of acquirees, acquisitions based on the number of non-overlapping industries with regards to the acquiree, expenditure in research and development (R&D), and a number of patents.

3. The method of claim 1, wherein the financial index is defined as
$$INDE {X}_{t} = INDE {X}_{t - 1} * ( 1 + \frac{{\sum }_{i = 1}^{{n}_{t}} \frac{{P}_{t}^{i} - {P}_{t - 1}^{i}}{{P}_{t - 1}^{i}}}{{n}_{t}} ) , {n}_{t} ∈ \{ 1 , … , 100 \}$$
where P representing the average percent change in equity prices, and t represents time.

4. The method of claim 1, wherein the final score is defined as:
FS_{c}=10*GFS_{c}+20KFS_{ck}+10*CS_{c}+10*AIS_{c}+10*ACS_{c}+7.5*AbsRDS_{c}+7.5*RelRDS_{c}+25*TPS_{c}
where FS_{c} is the final score of a company, GFS_{c} is a general features score, KFS_{ck} is a cornerstone feature score, CS_{c} is a score assigned to the number of countries where it operates, AIS_{c} is a score assigned to acquisitions based on the geographical location of the acquirees, ACS_{c} is a score assigned to acquisitions based on the number of non-overlapping industries with regards to the acquiree, AbsRDS_{c} is a score assigned to absolute expenditure in research and development (R&D), RelRDS_{c} is a score assigned to the ratio between it R&D expenditure and revenues, TPS_{c} is a total score assigned to the number of patents the company has filed throughout history.

5. The method of claim 4, wherein the general feature score GFS_{c} is defined as:
GFS_{c}=EW_{c}*FS_{c}
where EW_{c} represents an essential features weight for company c and FS_{c} represents a general intermediate feature score.

6. The method of claim 5, wherein the general intermediate feature score FS_{c} is a sum of individual feature scores, each individual feature score defined by:
$$F {S}_{f} = \frac{1 - \frac{{n}_{f}}{N}}{F - {\sum }_{f = 1}^{f = I} \frac{{n}_{f}}{N}}$$
where n _{f} represents the number of companies (C) with the feature (the subindex f represents each feature), N represents the total number of companies under analysis, F represents a total number of features, and FS_{f} represents the score for a given feature.

7. The method of claim 5, wherein the essential features weight EW_{c} for company c is defined as:
$$E {W}_{c} = \frac{{e}_{c}}{E}$$
where EW_{c} represents an essential features weight for company c, e_{c} represents the number of essential features present in company c, E represents the total number of features.

8. The method of claim 4, wherein the cornerstone feature score KFS_{ck} is defined by:
KFS_{ck}=KEW_{ck}*KFS_{fk}
where KEW_{ck} represents an essential features weight for company ck and KFS_{fk} represents a specific score for a given feature in that cornerstone.

9. The method of claim 8, wherein the cornerstone feature score KFS_{ck} is defined by:
$$K F {S}_{f k} = \frac{1 - \frac{{n}_{fk}}{{N}_{k}}}{{F}_{k} - {\sum }_{fk = 1}^{fk = Ik} \frac{{n}_{f k}}{N}}$$
where n_{fk} is the number of companies in that cornerstone with a feature (the subindex fk represents each feature from that cornerstone), Nₖ is the total number of companies under analysis that operate within a given cornerstone, Fₖ is the total number of features for a given cornerstone, KFS_{fk} is the specific score for a given feature in that cornerstone.

10. The method of claim 8, wherein the essential features weight KEW_{ck} is defined by:
$$K E {W}_{c k} = \frac{k {e}_{c k}}{k E}$$
where KEW_{ck} is the essential features weight for company ck, e_{ck} is the number of essential features present in company ck, E is the total number of features.

11. The method of claim 4, wherein the score assigned to the number of countries where the company operates CS_{c} is defined by:
$${CS}_{c} = \frac{A s c e n d i n g R a n k ( {Countries}_{c} )}{C}$$
where C is the total number of companies in the index.

12. The method of claim 4, wherein the score assigned to acquisitions based on the geographical location of the acquirees AIS_{c} is defined by:
$${AIS}_{c} = \frac{A s c e n d i n g R a nk ( \sum {Overlap\_Weigth}_{a} )}{C}$$
where Overlap_Weightₐ, is sum of non-overlapping industries over the total number of industries in which the acquiree operates, a refers to the acquisition, and C is the total number of companies in the index.

13. The method of claim 4, wherein the score assigned to acquisitions based on the number of non-overlapping industries with regards to the acquiree ACS_{c} is defined by:
$$A C {S}_{c} = \frac{AscendingRank ( \begin{matrix}\sum {InternationalAcquisitions}_{c} + \\ \frac{S a m e C o u n t {ryAcquisitions}_{c}}{2}\end{matrix} )}{C}$$

14. The method of claim 4, wherein the score assigned to absolute expenditure in research and development (R&D) AbsRDS_{c} is defined by:
$$A b s R D {S}_{c} = 7.5 * \frac{A s c e n d i n g R a n k ( R \& {D \_ Expenditure}_{c} )}{C}$$
where C is the total number of companies in the index and c is the company.

15. The method of claim 4, wherein the score assigned to the ratio between R&D expenditure and revenues RelRDS_{c} is defined by:
$$R e l R D {S}_{c} = 7.5 * \frac{A s c e n d i n g R a n k ( \frac{R \& {D \_ Expenditure}_{c}}{R e v e n u {e}_{c}} )}{C}$$
where C is the total number of companies in the index and c is the company.

16. The method of claim 4, wherein the total score assigned to the number of patents the company has filed throughout history TPS_{c} is defined by:
TPS_{c}=0.2*PS_{c}(<−2)+0.3*PS_{c}(−2)+0.4*PS_{c}(−1)+0.1*PS_{c}(0)
where PS_{c} is a score based on a rank of a number of patents filed by the company c in a given period.

17. The method of claim 16, wherein the score based on the rank of the number of patents filed by the company is defined by:
$$P {S}_{c} ( t ) = \frac{A s c e n d i n g R a n k ( P a t e n t {s}_{c} ( t ) )}{C}$$
where C is the total number of companies in the index and t is time.

18. The method of claim 1, wherein the number of companies selected from each category is between and including 3 and 15.

19. The method of claim 1, wherein a number of selected companies is 50.

20. The method of claim 1, wherein a number of selected companies is 100.
